(19) United States
(12) Patent Application Publication
(10) Pub. No.: US 2006/0220943 A1
(43) Pub. Date: Oct. 5, 2006

(54) Device for measuring the distance and speed of objects

(76) Inventors: Michael Schlick, Leonberg (DE); Juergen Hoetzel, Florstadt (DE); Rainer Moritz, Filderstadt (DE)

Correspondence Address: KENYON & KENYON LLP, ONE BROADWAY, NEW YORK, NY, 10004, US

(21) Appl. No.: 10/538,558

(22) PCT Filed: Dec. 9, 2003
(86) PCT No.: PCT/DE03/04059

§ 371 Date: Apr. 12, 2006

(30) Foreign Application Priority Data
Dec. 11, 2002 (DE) 102 58 097.9

(51) Int. Cl. G01S 13/93

(52) U.S. Cl. 342/70; 342/109; 342/82; 342/84

(57) ABSTRACT

Transmitted and received radar pulses are correlated in a receiver-side mixer for the measurement of the clearance distance and the speed of objects, using radar pulses. In a control device for specifying range gates, transmitter-side radar pulses that are able to be supplied to the mixer are continuously changed increasingly and/or decreasingly with respect to their pulse delay. Using a switchover device, one may switch over to the Doppler frequency measuring operation or reset to the clearance distance measuring operation.

### FIELD OF THE INVENTION

The present invention relates to a device for measuring the clearance distance and the speed of objects using radar pulses.

### BACKGROUND INFORMATION

Radar pulses are emitted for detecting objects using radar sensors, according to German Published Patent Application No. 19963006. The pulses reflected from a target object are evaluated in such a way that different location resolutions and different dimensions with regard to distance and length of a virtual barrier may be achieved. The received radar pulses are correlated with delayed transmitter-side radar pulses in a receiver-side mixer. Speeds are measured via differential frequencies (Doppler frequencies between the transmitted oscillator frequency and the signal reflected by the target and received). Such radar sensors having primary information distance find application as parking aids, ACC, Stop&Go Operation and blind spot detection in the motor vehicle field. For precrash sensing, the primary information is the speed.

### SUMMARY OF THE INVENTION

Using a receiving-side mixer that correlates received radar pulses with delayed transmitter-side radar pulses, a control unit for specifying range gates within which the radar pulses that are to be supplied to the mixer are able to be continuously changed increasing or decreasing with respect to their pulse delay, a switching device for realizing a plurality of operating modes, especially for holding constant the transmitter-side radar pulses, to be supplied to the mixer, with respect to their delay, so as, in particular, to measure Doppler frequencies, for resetting or increasing the delay to a current or a new starting value and/or more continuous change of the delay especially to a direction that is opposite to a preceding change, and an evaluation device for distance and speed values made in the light of mixer output signals, a radar sensor is able to fulfill simultaneously several functional requirements, such as parking assistance, precrash and ACC, Stop&Go, and undertake a necessary intelligent switchover, so that, at each point in time, each of the functions receives the data it needs within specified tolerance ranges. Conflicts conditioned on the situation, especially measuring conflicts, may be avoided thereby.

A mode switchover from clearance measuring EM to speed measuring GM is not able to take place at just any time. On account of the sweep method (continuous change of the transmitter-side radar pulses, supplied to the mixer, with regard to its delay) time delays may occur here. Using the measures of the present invention, these time delays may be prevented or reduced.

In the operating mode of distance measuring, ambiguities, such as phantom objects and apparent reflections may occur. In the case of a one-sensor configuration and tracking of a plurality of targets, ambiguities correspond to two objects (that are approaching) are located at the same distance point, and, based on the measuring data alone, cannot be distinguished as to whether there is one or the actual number of objects. In the case of a one-sensor configuration and the tracking of a plurality of targets, ambiguities mean that an object has a plurality of reflection centers at different distances, and, only based on the distance information of the radar sensor, it cannot be distinguished whether a plurality or one object is involved. Phantom objects occur during distance measurement because of the most varied, radar-specific effects, such as Doppler reflections, interfering transmitters, . . . . On the other hand, in the case of a two-sensor configuration and the use of triangulation methods, apparent reflections may occur that misrepresent objects at a location where there is no object. Such ambiguities, phantom objects and apparent reflections may be drastically reduced by using the measures according to the present invention. It is also possible to lift the restriction on the speed measurement to following only one object, and to ensure the same multi-target capability as with the distance measurement, and at the same time to carry out a relative speed measurement via Doppler.

Moving objects may be detected based on an increasing speed gradient/amplitude. The position of a movable object may also be detected based on the maximum amplitude in the Doppler frequency measurement. A speed offset of an object may also be estimated from the detected position. When there is a range gate change, a Doppler frequency measurement is possible by the simple control of the switchover device. The switchover device may also be able to be controlled in an event-triggered manner, so that, based on a detected reflection, the system may get to operating mode speed measurement or to a change in the delay of the radar pulses supplied to the mixer on the transmitter side in the opposite direction.

A plausibility check of objects may take place by the evaluation of additional reflections, especially if the delay of the transmitter-side radar pulses supplied to the mixer is undertaken in the opposite direction after a detected reflection.

A clearance distance history for the detection of object patterns may be made up from the distance measurements obtained.

Based on speed measurements, estimated values for expected crash situations may be drawn up. In particular, one may switch over into operating mode speed measurement in order to measure Doppler frequencies.

### BRIEF DESCRIPTION OF THE DRAWINGS

FIG. 1 shows a schematic basic circuit diagram of a device according to the present invention.

FIGS. 2 to 4 show various strategies using combined measuring modes.

FIG. 5 shows the distance measuring operation.

FIG. 6 shows the speed measuring operation.

FIG. 7 shows an object detection.

FIG. 8 shows a position detection.

FIG. 9 shows estimated speed offsets.

FIG. 10 shows preparation of situation analyses.

FIG. 11 shows a precrash time sequence.

### DETAILED DESCRIPTION

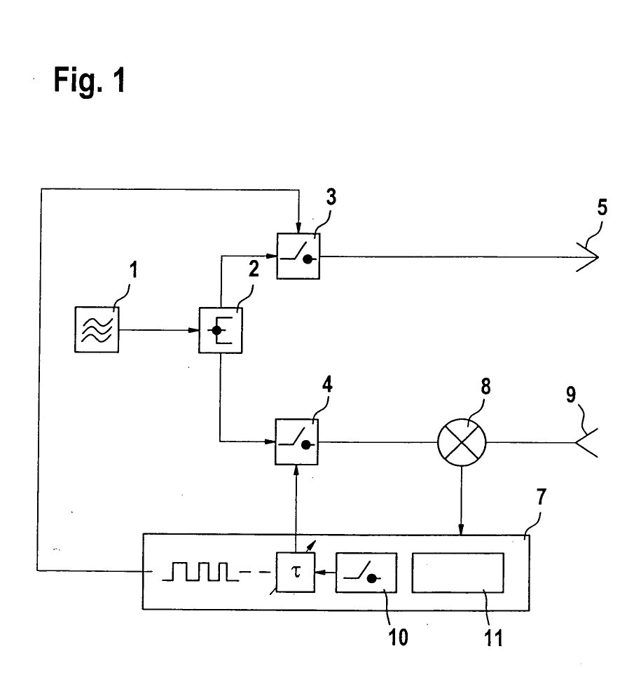

In principle, the clearance distance measurement takes place by an indirect travel time measurement of an emitted radar pulse. For this, according to FIG. 1, a carrier frequency oscillator 1 is provided, having an oscillation frequency around 24 GHz, which passes on its oscillation frequency to two switches 3 and 4. The oscillation frequency is pulse-frequency modulated by switch 3, so that radar pulses reach transmission antenna 5, whose repetition frequency and width are specified by pulse frequency generation 6 within control device 7. The indirect travel time measurement takes place by the evaluation using a receiving-side mixer 8, which correlates the radar pulses received by receiving antenna 9 with radar pulses in each case delayed by a specified time, which reach mixer 8 via switch 4. If a low-frequency signal is present at the output of mixer 8, the travel time of the reflected radar pulse corresponds to pulse delay dt, and the distance of the reflecting object may be calculated by the equation s=0.5*dt*c (evaluating device 11).

The speed measurement takes place using the evaluation of the Doppler frequencies (evaluation device 11), which are also present at the output of mixer 8. For this, pulse delay dt is held until an object at a relative speed v has approached the radar by s.

One should note, in this instance, that s has exactly a width of b=2*pd*c, which is proportional to the duration pd of the radar pulse. This discrete ,,clearance distance point” having extension b is called the range gate. The specification of the range gates within which the transmitter-side radar pulses that are to be supplied to mixer 8 (via switch 4), with respect to their pulse delay, are continuously changeable increasing and/or decreasing, also takes place via control device 7, for example, via appropriately controllable delay lines.

The radar pulse sensor being looked at here is not able to measure distance and speed in parallel, but is able to have more than one mixer, having the same pulse delay dt for all mixers. In the distance mode EM, the radar sensor sweeps through pulse delay dt, and consequently a certain distance range continuous change of the pulse delay). Using appropriate evaluation software, in this connection a plurality of targets may be tracked. In speed mode GM, to which one may switch over via a switchover device 10 within control device 7, pulse delay dt is held until the object to be measured has penetrated into the range gate and generates a Doppler frequency at the mixer output (IFout). If the Doppler information has been read off, the radar sensor may switch over to a next range gate with regard to pulse delay dt, and wait for the next Doppler information.

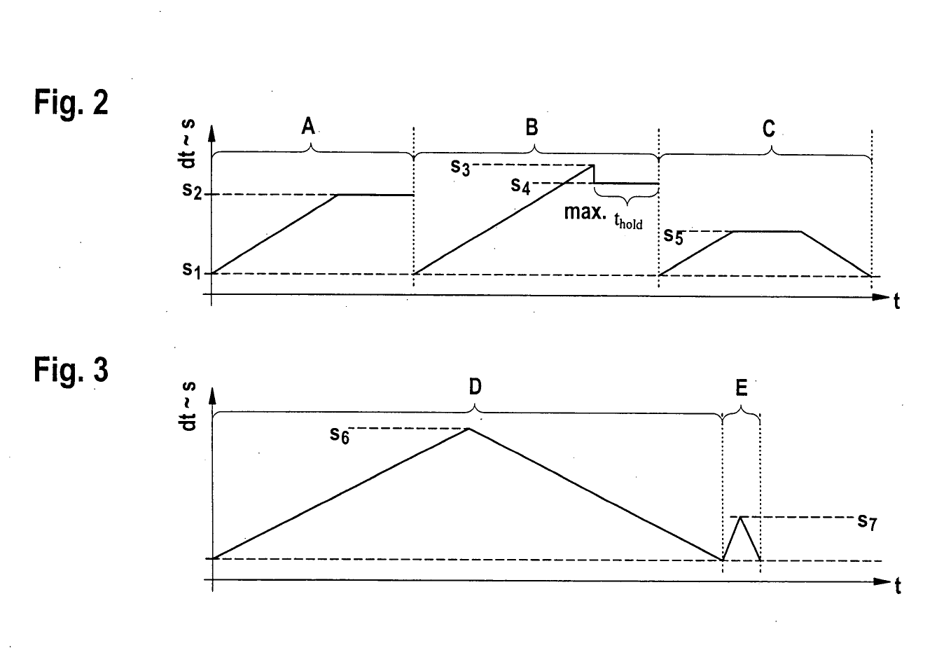

In the following, we describe strategies as to how pulse delay dt may be activated in such a way that a combined measuring mode is created, which combines the characteristics of distance mode EM and speed mode GM. The strategies are illustrated in FIGS. 2 through 4.

Strategy A (FIG. 2):

Beginning at close range s1, the region away from the radar sensor is searched for reflecting objects. At s2 this procedure is broken off. Pulse delay dt is held to a constant value, which now makes it possible to measure Doppler frequencies at s2. At the earliest after a recorded Doppler frequency and at the latest after a maximum holding period, pulse delay dt is reset/switched back to dt=2*s1/c (current starting value.

Strategy B (FIG. 2):

Beginning at close range s1, the range of the sensor path is searched using continuously increasing pulse delay. At s3 an object 01 is detected. In order to assign to object 01 a low-tolerance relative speed such as the Doppler information, pulse delay dt is switched back to dt=2*s4/c, using switchover device 10. At the earliest after a recorded Doppler frequency and at the latest after a maximum holding period, pulse delay dt is switched back again to dt=2*s1/c. If no relative speed is able to be assigned to object 01, one may assume that the object has distanced itself. In this connection, after holding period tHalte, a dt=2*(s3+Δs)/c may be set, in an analogous manner. (S3-s4) and Δs are to be applied. If again no relative speed is able to be assigned to object 1, the procedure is broken off. This, in addition, improves the performance for suppressing apparent reflections and ambiguities, since apparent reflections have no relative speed. By contrast, ambiguities in many cases have a nonuniform relative speed. This applies especially to multi-sensor configurations.

Strategy C (FIG. 2):

A range gate at s5 is approached by a scan of s1. After ascertaining the Doppler frequency or a tHalte, the range between s5 and s1 is searched one more time using opposing pulse delay. In that way it may be excluded that, by the setting of a range gate, an object closer that s5 is overlooked. On account of the repeated scanning, the determination of the distance may be improved for an additional range gate for an object having a plurality of different reflection centers. This further improves the performance for suppressing apparent reflections and ambiguities.

Strategy D (FIG. 3):

Permits an immediate plausibility check of an object which for the first time has approached closer than s6 to the radar sensor. This is necessary in case a detection decision has to be made at a distance that is closely below s6.

Strategy E (FIG. 3):

The slope steepness lowers the sensitivity, but also the scanning cycle. If an algorithm is expecting an object having a large radar cross section, a lower sensitivity for checking presence is sufficient. Here too, because of the downward slope, a plausibility check that is as early as possible takes place for the more distant objects at s7.

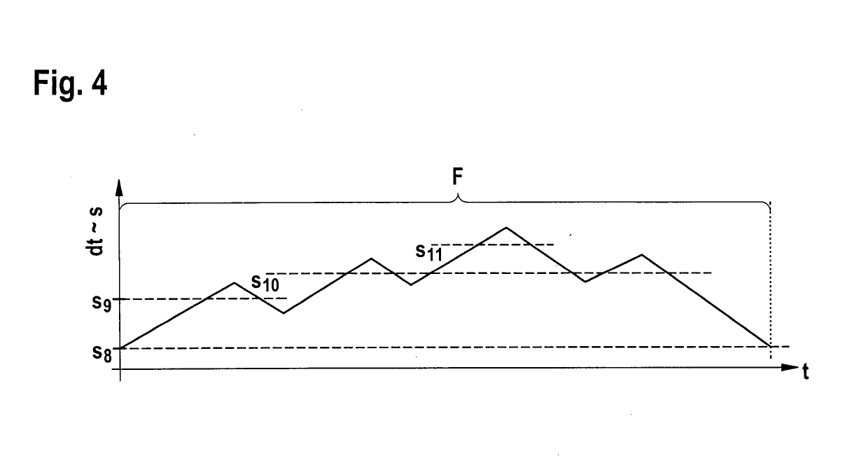

Strategy F (FIG. 4):

Permits a faster plausibility check of any desired object as soon as it has become detected by the signal processing. As soon as a reflection is detected, a pulse delay dt is lowered again in the opposite direction, in order to obtain an increased plausibility by an additional reflection and less susceptibility to phantom objects. In one cycle, object s10 is checked for plausibility 6 times, while s11 is checked twice, i.e. the closest-lying objects have their plausibility checked best. The object at s9 has not been tracked further in this exemplary scenario as a phantom object. In this instance, s8 is the shortest reach of the sensor. If one puts the emphasis on the plausibility checking of objects that have just entered the reach of the radar sensor, s8 may be substituted by the maximum reach of the radar sensor and the scanning direction towards the radar sensor may be reversed.

The combination of the various strategies also brings along additional advantages, such as the combination of strategies D and A. If s6 is the maximum reach of the radar sensor, each object of an object list that was generated from this may be supplemented by one or more measuring strategies A using relative speeds derived from Doppler data.

The strategy may also be formed in such a way that, after each change of range gates, a switchover from distance measuring to speed measuring is undertaken.

Control device 7 may be designed as a microcontroller, and may assume the tasks of pulse frequency generation 6 (clock pulse, for instance 5 MHz), pulse delay, switchover 10 and evaluation 11.

Evaluation device 11 may determine the limits of the range gates, in the light of the ascertained speed values.

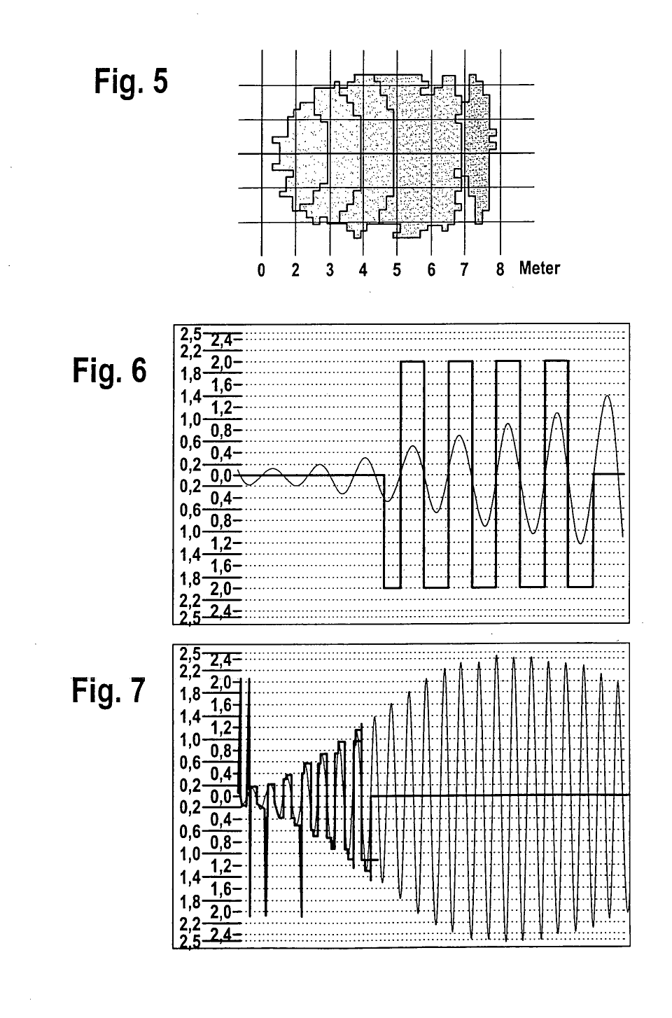

FIG. 5 shows the distance measuring operation in scan mode. Various range gates have different shades of gray.

FIG. 6 shows the speed measuring operation, including detection of half waves (Doppler frequency). A binary signal is formed from the half waves in order to determine the zero crossings, and therewith the Doppler frequency, more accurately.

FIG. 7 shows an object detection based on an increasing amplitude/gradient in the speed measuring operation.

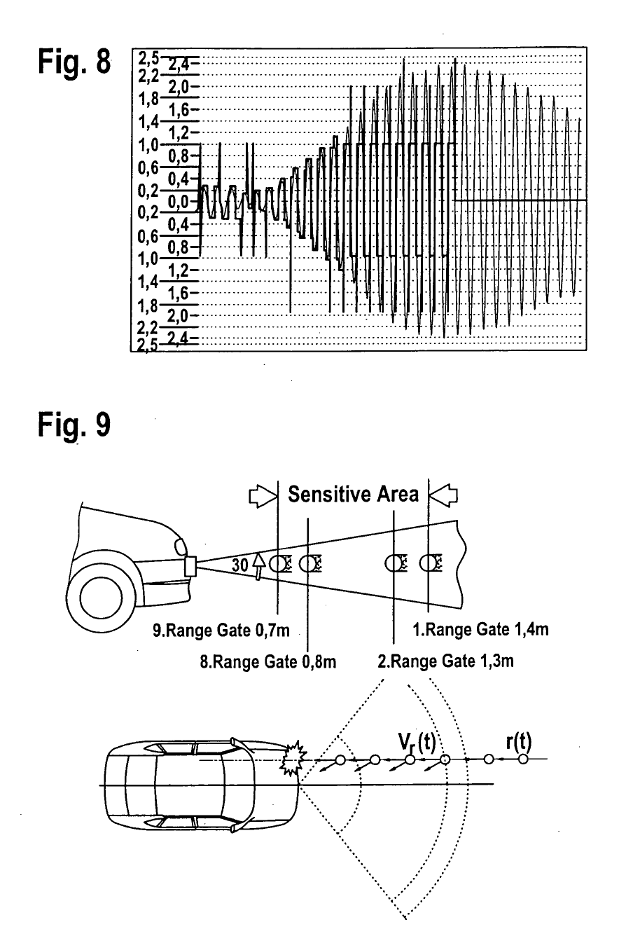

FIG. 8 is used for illustrating the detection of the position of a moving object, based on the maximum amplitude reached in the Doppler frequency measuring. From the detected position of an object, a speed offset—vector Vr(r)—within a range gate may also be estimated (FIG. 9).

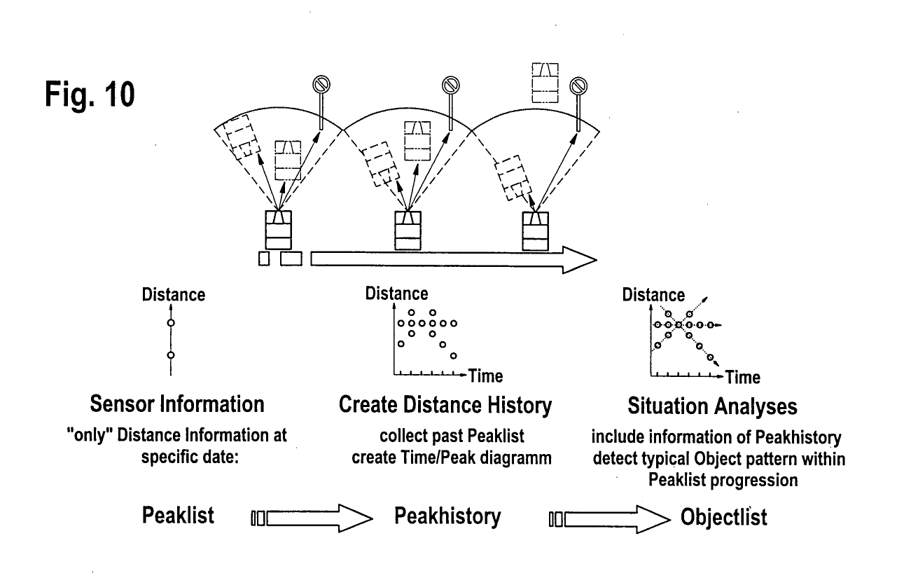

FIG. 10 shows how a clearance distance history (distance history) may be drawn up from individual target measurements by collecting individual measurements (collect past peak list) and setting up a time/peak diagram. From this, a situation analysis may be drawn up and a detection of object patterns in the light of the progression of the peak list. This is important especially for the estimation of expected crash situations.

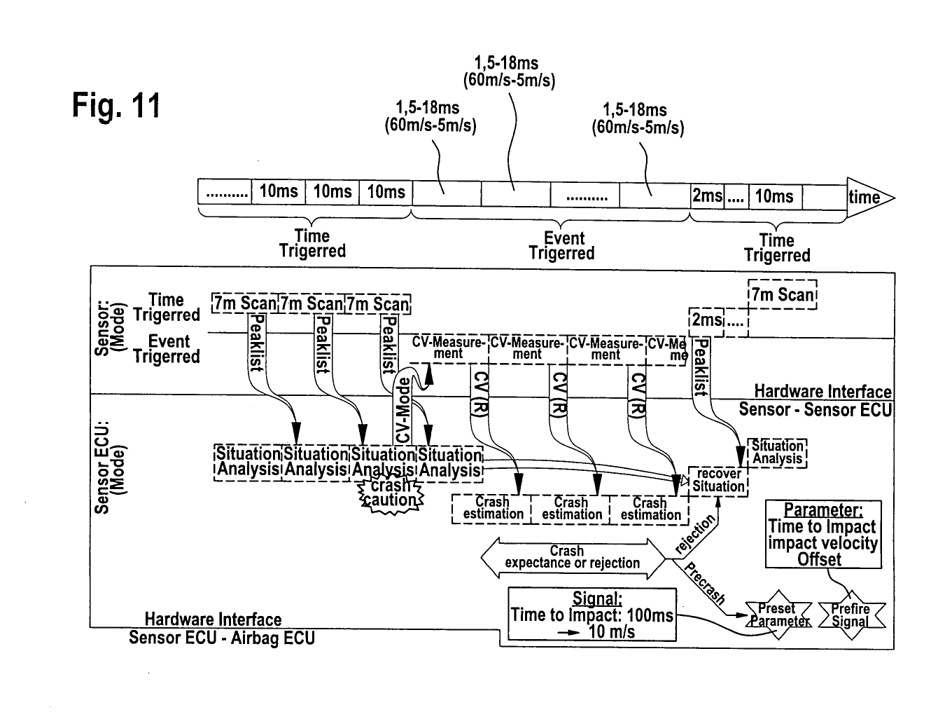

FIG. 11 shows a precrash time sequence. The distance measurements are time-triggered (within 10 ms a 7 m range is scanned in each case). The speed measurements are event-triggered in the range of 1.5 to 18 ms. From the processing of the measured values, crash situations may be estimated for the purpose of giving out advance warning signals for an expected crash (prefire signal) or parameters for the triggering of an air bag or the correction of the approaching speed (preset parameters).

1.-12. (canceled)

13. A device for measuring a clearance distance and a speed of an object using radar pulses, comprising:
a receiver-side mixer that correlates received radar pulses with delayed transmitter-side radar pulses;
a control device for specifying range gates within which radar pulses that are to be supplied to the mixer are continuously changeable increasingly and/or decreasingly with respect to their pulse delay;
a switchover device for at least one of:
implementing a plurality of operating modes for holding constant transmitter-side radar pulses that are able to be supplied to the mixer with respect to their delay, in order to measure Doppler frequencies,
for one of resetting and raising the delay to one of a current starting value and a new starting value, and
for producing a continuous delay into a direction that runs opposite to a preceding change; and
an evaluating device for determining distance and speed values in response to an output signal from the mixer.

14. The device as recited in claim 13, wherein the evaluating device prognosticates speed values from established distance changes that are one of verified and finely corrected based on the measured Doppler frequencies.

15. The device as recited in claim 13, wherein the evaluating device determines limits of the range gates based on the ascertained speed values.

16. The device as recited in claim 13, wherein the switchover device is controllable by the control device in such a way that, in response to a range gate change, a Doppler frequency measurement is made by holding constant the delay of the transmitter-side radar pulses that are able to be supplied to the mixer.

17. The device as recited in claim 13, wherein the evaluating device detects a moved object based on an increasing speed gradient/amplitude.

18. The device as recited in claim 13, wherein the evaluating device detects a position of a moving object based on a maximum amplitude of the Doppler frequency measurement.

19. The device as recited in claim 18, wherein the evaluating device estimates a speed offset for a detected position of the object.

20. The device as recited in claim 13, wherein the switchover device is controllable in an event-triggered manner corresponding to a switchover to another operating mode by holding constant the delay of the transmitter-side radar pulses supplied to the mixer in the case of one of the previous variation of the delay and the changing of the delay into the opposite direction based on a detected reflection.

21. The device as recited in claim 13, wherein, for a plausibility check of an object detection in response to a detected reflection, the delay of the transmitter-side radar pulses that are able to be supplied to the mixer are changeable in the opposite direction in such a way that an additional reflection may be obtained which is able to be correlated with the previously detected reflection.

22. The device as recited in claim 21, wherein the evaluating device draws up a clearance distance history from clearance distance measurements and detects object patterns based on the clearance distance history.

23. The device as recited in claim 13, wherein the evaluating device draws up estimated values for the speed measurements for expected crash situations.

24. The device as recited in claim 23, wherein the evaluating device, in response to expected crash situations, controls the switchover device into the operating mode of holding constant the radar pulses with respect to their delay, in order to measure Doppler frequencies.
